(19) United States
(12) Patent Application Publication
(10) Pub. No.: US 2014/0284921 A1
(43) Pub. Date: Sep. 25, 2014

(54) COUPLING DEVICE, LINE PATH AND LINE END SECTION

(71) Applicant: Andries van der Valk, Haarlem (NL)

(72) Inventor: Andries van der Valk, Haarlem (NL)

(21) Appl. No.: 14/350,157

(22) PCT Filed: Oct. 3, 2012
(86) PCT No.: PCT/NL2012/050691

§ 371 Date: Apr. 7, 2014

(30) Foreign Application Priority Data
Oct. 7, 2011 (NL) 2007552
Oct. 11, 2011 (TW) 100136748

(51) Int. Cl. F16L 37/18; F16L 37/248

(52) U.S. Cl. CPC F16L 37/18; F16L 37/248
USPC 285/312

(57) ABSTRACT

A coupling device (1) for connecting and/or closing off fluid lines (60) includes:
a male coupling element (2) having a continuous recess (5) provided around the outer circumference and one radial projection (6);
a female coupling element (3) having an arm (9) which includes, at one end, an operating element (10) and, at an opposite end, at least one radially extending locking element (11). The female coupling element (3) further includes a slot (108) that extends in axial direction and is a breather duct when the arm (9) is in the first position;
a bayonet fastening which is formed by a labyrinth-like guide (12) in the wall (7) of the female coupling element (3) and the radial projection (6) of the male coupling element (2). Also described are a line path and a line end section in which the coupling device has been accommodated.

The present invention relates to a coupling device for connecting and/or closing off fluid lines, comprising:
a male coupling element having a substantially circular cross section, at least one continuous recess provided around the outer circumference and at least one projection which extends substantially radially;
a female coupling element which has a wall with a substantially circular cross section which surrounds a receiving space in which the male coupling element can be accommodated in a fitted manner, wherein the female coupling element has at least one arm which, at one end, comprises an operating element and, at an opposite end, at least one radially extending locking element, wherein the arm is rotatably connected to the female coupling element, wherein the wall has at least one recess through which the locking element can extend into the receiving space, wherein the arm can be brought into a first and a second position, wherein, in the first position, the locking element is situated substantially outside the receiving space and the male coupling element can be brought freely into and/or out of the receiving space, wherein, in the second position, it extends substantially inside the receiving space and engages with the at least one continuous recess provided around the outer circumference of the male coupling element, as a result of which a connection between the coupling elements is established in the position in which the coupling elements are accommodated entirely inside one another, wherein the wall of the female coupling element comprises at least a labyrinth-like guide, wherein the labyrinth-like guide comprises at least one entrance which opens in a free peripheral edge of the wall, at least one guide part which extends substantially in the axial direction from the entrance and at least one guide part which adjoins the axial guide part and extends substantially in the circumferential direction, wherein the radial projection, via the entrance in the axial guide part and the guide part extending in the circumferential direction, can be positioned in the labyrinth-like guide in order to establish the bayonet fastening.

The invention also relates to a line path and a line end section in which the coupling device according to the present invention is accommodated.

Such a coupling device for connecting liquid-carrying hoses is known from GB 2211258 A. This coupling device, which is generally known and referred to as a cam-and-groove coupling and/or cam lock coupling, comprises a hollow male part provided with a continuous recess provided on the outer circumference, a female part which is provided with a receiving space in which the male part can be accommodated. The female part furthermore comprises one or more arms which are provided, at one end, with a cam, wherein the cam is situated outside the receiving space of the female part in a first position and the male part can be freely moved into and/or out of the receiving space of the female part. By rotation, the arms can be brought into a second position, wherein the cams extend inside the receiving space when the male part is situated in the receiving space of the female part and can engage with the continuous recess provided in the outer circumference of the male part. As a result, the coupling device is fastened and a connection between the male and the female part is brought about.

The male part of the known coupling device furthermore comprises a pin which can be accommodated in a duct which is provided in the wall of the female part which surrounds the receiving space. The bayonet fastening which is formed in this way can prevent the male and the female parts of the coupling device from flying apart when the arms are moved from the second to the first position while the hoses are (still) under pressure.

A drawback of the coupling device known from GB 2211258 A is that when the arms of the coupling device, be it knowingly or inadvertently, are moved from the second to the first position and the connection between the male and the female part has been broken, the bayonet fastening could, at least partly, be rotated open, for example due to torsion which is present in the connected hoses. As a result, the bayonet fastening will offer at least a limited degree of protection against flying apart of the male and female parts of the coupling device due to the pressure under which these parts are when a liquid still flows through the coupled hoses. Thus, there is a risk of injury to people and/or damage to infrastructure in the area surrounding the male and female parts of the coupling device which fly apart.

A further drawback of the coupling device known from GB 2211258 A is the fact that it will be relatively expensive due to the fairly laborious implementation of the components required for the bayonet fastening.

It is an object of the present invention to provide a coupling device for connecting and/or closing off fluid lines which eliminates the abovementioned drawbacks or at least reduces them by offering at least improved protection against the male and the female coupling elements flying apart during the uncoupling of the coupling device, whether knowingly or inadvertently, due to at least partly rotating the bayonet fastening open as a result of an uncontrolled force, for example as a result of torsion and/or vibrations, which acts on the male and/or female coupling elements, in combination with the pressure under which these elements are when there is still fluid present, for example a liquid or a gas, in at least one connected fluid line.

It is a further object of the present invention to provide a coupling device which can establish the abovementioned improved protection in a simple and inexpensive manner.

At least one of these objects is achieved by a coupling device according to the present invention, wherein the guide part which extends substantially in the circumferential direction is locally widened in the axial direction to form at least one stop, wherein the male and female coupling elements accommodated inside one another can be brought into a position in which the radial projection and the at least one stop overlap one another in such a manner that a movement of the male coupling element substantially in the circumferential direction is limited and that it is possible to prevent an uncontrolled force directed in the axial and/or circumferential direction from taking the radial projection past the at least one stop, wherein the receiving space further comprises a seat that is arranged in a direction transverse to the wall and opposite the free circumferential edge, wherein in axial direction the wall comprises a first and a second part that are connected in circumferential direction via a connection element, wherein a first end of the first part is connected to a first side of the seat that is arranged facing the receiving space and a second end of the first part is connected to a first end of the connection element that is arranged facing the seat, wherein the first part comprises the at least one recess, wherein a first side of the first part that is arranged facing the receiving space comprises a slot that extends from the seat substantially in axial direction and is connected to the at least one recess and/or to the connection element.

As a result, a coupling device is provided by means of which it is possible to prevent the male coupling element from becoming detached from the female coupling element. The female coupling element typically has two arms. If these arms are brought from the second position to the first position, whether knowingly or inadvertently, when a fluid, for example a liquid or a gas, flows through the fluid lines, the male and the female coupling element will be moved in opposite directions due to forces that are exerted on them due to the pressure of the fluid. As a result, the radial projection of the male coupling element will be moved into a widening which extends in the direction of the free circumferential edge of the female coupling element of the guide part of the labyrinth-like guide and which is directed substantially in the circumferential direction. As a result, a movement of the radial projection and thus a movement of the male coupling element substantially in the axial direction is limited and the radial projection is prevented from flying out of the labyrinth-like guide.

If an uncontrolled force directed in the axial and/or in the circumferential direction then unexpectedly acts on the coupling elements of the coupling device, for example as a result of torsion in the flexible and/or semi-flexible fluid lines, such as hoses, connected to the male and the female coupling element, at least one stop can come into overlapping contact with the radial projection of the male coupling element. Consequently, the movement of the radial projection and thus of the male coupling element substantially in the circumferential direction will be limited to such a degree that the radial projection cannot move past the stop and therefore cannot get outside the labyrinth-like guide. This makes it possible to prevent the male coupling element from flying off the female coupling element and causing injury to a person and/or damage to the infrastructure which is situated in the vicinity of the coupling device.

If a fluid line is to be closed off, the male or the female coupling element acts as a closure element, for example a cap. In an analogous way to that described above, the coupling device according to the present invention can prevent, for example, vibrations which may be caused in the closed-off fluid line, for example, by a connected pump, from causing the closure element to fly off the coupling device.

If a fluid is at least present in the fluid lines that are coupled to each other by a coupling device according to the present invention, these lines remain under pressure due to the fluid that is present in these lines. In a situation in which these lines are uncoupled, whether knowingly or inadvertently, by transferring the arms of the female coupling device from the second to the first position, the male and female coupling elements will be moved in opposite directions due to the forces that are exerted on them due to the pressure of the fluid as has been described above. Due to the presence of a slot in the first side of the first part of the wall of the female coupling part according to the present invention, wherein such a slot is connected to a recess in the first part of the wall of the female part and/or to the connection element that connects the first and second parts of that wall, the pressure in the fluid lines can efficiently be lowered. As a result, the forces on the male and female coupling elements can significantly be reduced. Consequently, the risk of injury to a person and/or damage to the infrastructure that is situated in the vicinity of the coupling device due to the male and female coupling elements flying off each other, can further be reduced.

In an embodiment of the coupling device according to the present invention, in a situation in which the male coupling element and the female coupling element are accommodated entirely inside one another, the slot can be closed off by a packing element that can be arranged between the seat and a free circumferential edge of the male coupling element. The packing element can be a resilient body, such as a rubber ring. By positioning the packing element between the seat of the female part and the free circumferential edge of the male coupling element, the slot in the first side of the first part of the wall of the female coupling element can be closed off. In this way, the coupling device according to the present invention remains leak proof when the arms of the female coupling element are in the second position and a fluid flows through the fluid lines that are coupled by the coupling device according to the present invention.

In an embodiment of the coupling device according to the present invention, in a situation in which the at least one arm of the female coupling element is in the first position, the slot is a breather duct. As described above, when the arms of the female coupling device are transferred from the second to the first position, the male and female coupling elements are moved in opposite directions with respect to each other due to the forces that are exerted on them by the pressure of the fluid in the lines that are coupled to the coupling device. In this case, one slot or breather duct according to the present invention could be sufficient for quickly releasing the pressure of the fluid in the lines. However, due to wear of the packing element it could get positioned slanted with respect to the seat of the female coupling element in a part of the receiving space between the seat and the free circumferential edge of the male coupling element. As a result, it could happen that the packing element still closes off the one slot in the first side of the first part of the wall of the female coupling element. Therefore, in order to improve the reliability of the pressure reduction capability of the coupling device at least two slots are preferred. A first slot could be connected to a recess in the first part of the wall through which the locking element of an arm can extend into the receiving space. A second slot could be connected to the connection element that connects the first and second parts of the wall of the female coupling element. It is also possible that two slots are arranged wherein each of them is connected to a recess in the first part of the wall. Another possibility is that two slots are arranged that are both connected to the connection element that connects the first and second parts of the wall of the female coupling element. It will be clear to the skilled person that in the case of even more slots many configurations are possible that fall within the scope of the present invention.

In an embodiment of the coupling device according to the present invention, the guide part extending in the circumferential direction is widened in the direction facing away from the free circumferential edge to form a first stop in such a manner that, when the male and female coupling elements are accommodated completely inside one another, the radial projection and the first stop overlap one another. Thus, it is possible to prevent the radial projection from moving in the circumferential direction through the labyrinth-like guide while the at least one arm is situated in the second position due to a force which is substantially directed in the circumferential direction.

In an embodiment of the coupling device according to the present invention, the guide part extending in the circumferential direction is widened in a direction facing the free circumferential edge to form a second stop in such a manner that when the male and female coupling elements are not accommodated completely inside one another, the radial projection and the second stop overlap one another. Thus, it is possible to prevent the radial projection from moving in the circumferential direction through the labyrinth-like guide while the at least one arm is situated in the first position as a result of a force which is substantially directed in the circumferential direction, and the male coupling element from flying off the female coupling element.

In an embodiment of the coupling device according to the present invention, the arm can be brought from the first into the second position when the male and female coupling elements are accommodated completely inside one another, wherein the radially extending locking element of the arm can engage with the at least one continuous recess provided along the outer circumference of the male coupling element. Thus, it is possible that after the bayonet fastening has been brought about correctly, the at least one continuous recess of the male coupling element provided along the outer circumference is arranged opposite the radially extending locking element of the arm and to bring about the connection of the male and the female coupling element in a correct and safe manner. This measure provides a coupling device with improved protection.

In an embodiment of the coupling device according to the present invention, the labyrinth-like guide is a slot in the wall of the female coupling element. By providing, for example by means of grinding and/or milling, a slot in the wall of the female coupling element, it is possible by means of a simple and inexpensive modification of a standard cam lock coupling and the use of a bayonet fastening to produce a coupling device which offers improved protection against the male coupling element flying out of the female coupling element. In this case, it is possible to position the radial projection, which is usually used to connect the male coupling element to the female coupling element by means of a connection, for example a small chain or a cord, in the labyrinth-like guide of the bayonet fastening. Thus, only the female coupling element of a further standard cam lock coupling has to be adapted which results in an inexpensive and/or quickly employable solution.

In an embodiment of the coupling device according to the present invention, the labyrinth-like guide is an internal groove in the wall of the female coupling element. This enables providing a bayonet fastening which can lead to an improved limitation of the movement of the radial projection substantially in the radial direction.

In an embodiment of the coupling device according to the present invention, the female and/or the male coupling element comprises a metal and/or a metal alloy. The use of metal offers the possibility of increasing the durability of the coupling elements and thus to increase the service life of the coupling device. This can have a positive effect on reducing the total costs of the coupling device. The choice of metal used will partly be determined by the properties of the metal and partly by the costs. For applications where the costs have to be as low as possible, stainless steel and/or carbon-containing ferro metals and/or brass are a suitable choice. Due to the hardness of stainless steel and/or a carbon-containing ferro metal, their use results in satisfactory durability which in turn leads to a long service life of the coupling device. Brass is not only a suitable choice due to its hardness, but also due to its good self-lubricating properties. For applications where costs at least are less important, titanium is a suitable choice, for example. This would make it possible to choose a thinner wall thickness of the coupling elements.

In an embodiment of the coupling device according to the present invention, the female and/or the male coupling element comprises a fibre-reinforced plastic. A suitable choice could be, for example, a plastic which has been reinforced with aramide fibre. This makes it possible to further minimize the weight of the coupling device without having to make significant concessions to strength or durability.

In an embodiment of the coupling device according to the present invention, the wall of the female coupling element has a thickness which is in the range from 1-10 mm, and is preferably 5 mm. Thus, depending on the material used, a wall is provided which has sufficient strength to withstand the forces which act on the coupling elements when in use.

According to another aspect of the present invention, a line path is provided, comprising at least two fluid lines which are connected to one another by means of a coupling device according to one of the preceding claims.

According to another aspect of the present invention, a line end section is provided, comprising at least one fluid line and a closure cap which are connected to one another by a coupling device according to one of the preceding claims. The closure cap may be formed by the male or the female coupling element of the coupling device. If the male coupling element is configured as the closure cap, it can be fitted and secured in the female coupling element of the coupling device in the same way as described above. Thus, a line end section is provided, wherein the coupling device according to the present invention prevents the closure element from flying out of the coupling device due to, for example, vibrations in the closed fluid line caused, for example, by a connected pump.

Although the invention will be described with reference to specific embodiments, the invention is not limited to the illustrated embodiments. The invention will be described by means of measures, wherein explicit advantages may be mentioned, but wherein there may also be implicit advantages. Any of these measures may be the subject-matter of the invention of this application or of a divisional application, some combinations of which measures have been described and/or illustrated explicitly in this description, but which may also be described implicitly. Although the figures show explicit combinations of measures, it will be clear to the skilled person that a number of these measures can also be applied separate from one another.

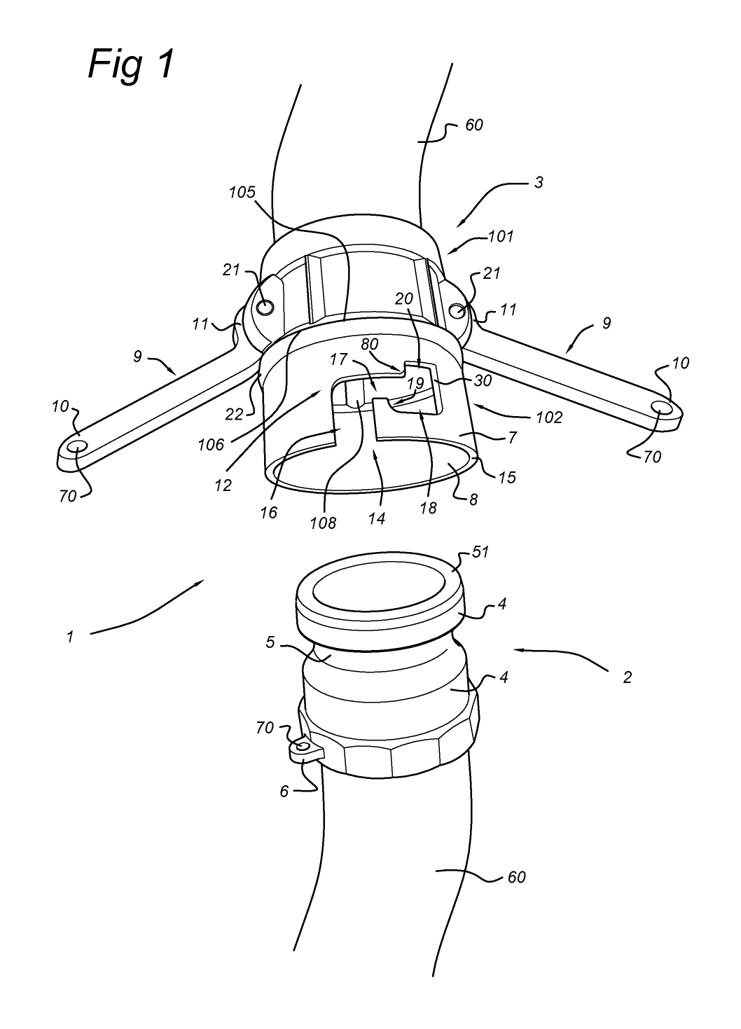

FIG. 1 shows an exploded view of an embodiment of the coupling device according to the present invention.

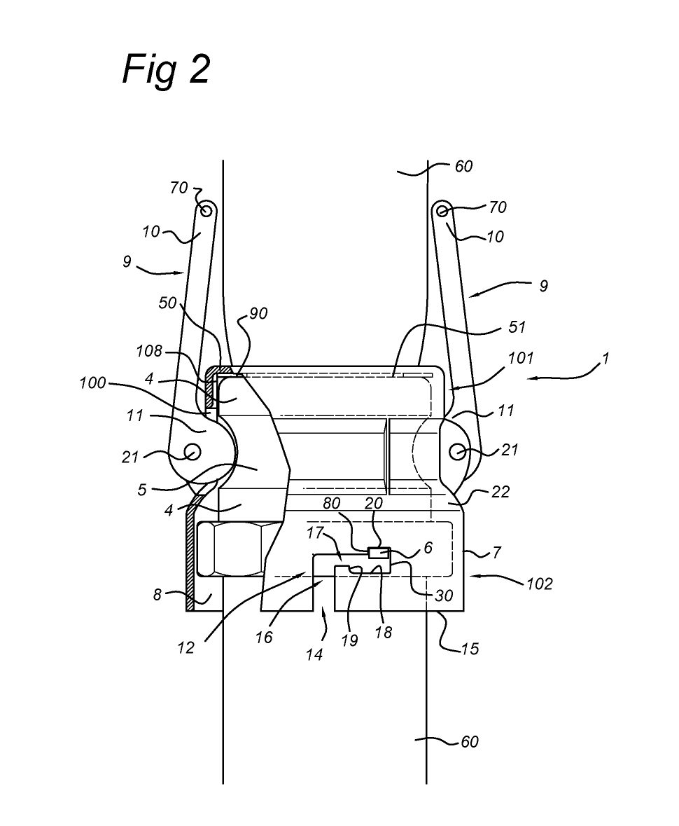

FIG. 2 shows a partly cut-away front view of a coupling device in the operating state according to the embodiment shown in FIG. 1.

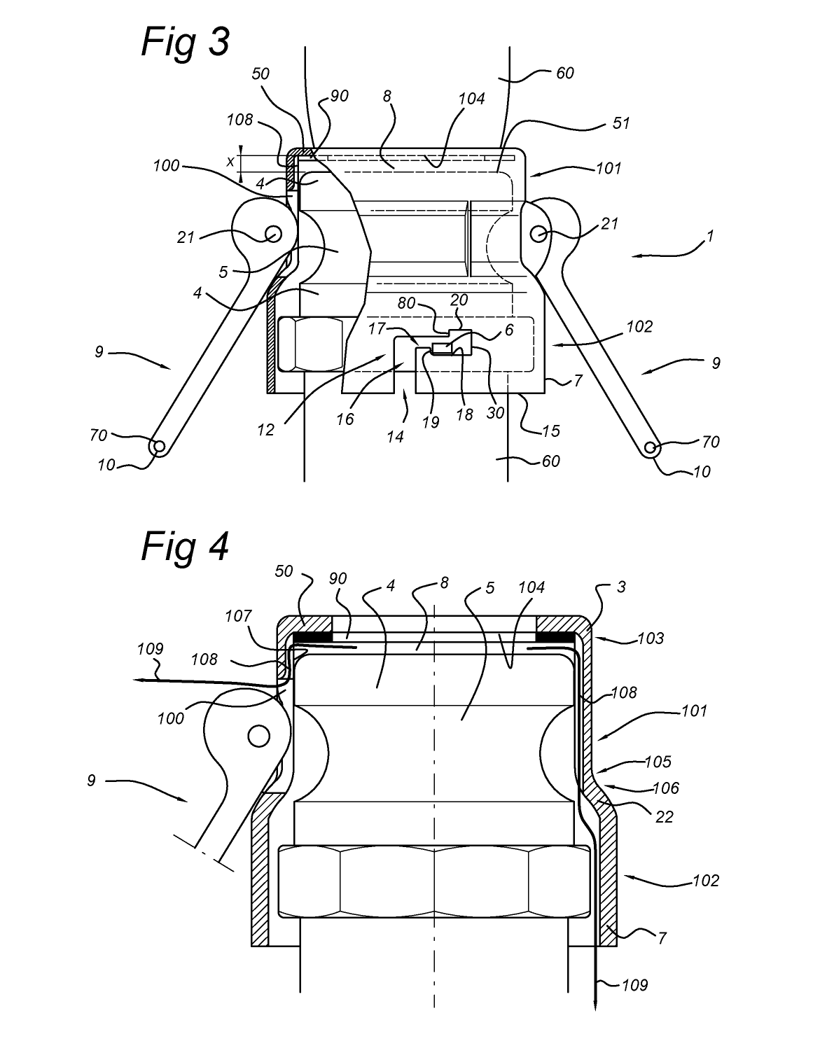

FIG. 3 shows a partly cut-away front view of the embodiment of the coupling device as shown in the preceding figures, wherein the operation of the stop in the labyrinth-like guide is illustrated diagrammatically.

FIG. 4 shows a combination of a cross-section of a female coupling element and a side view of a male coupling element that is inserted in the receiving space of the female coupling element. In this embodiment of the coupling device according to the present invention, two slots of the female coupling element are shown.

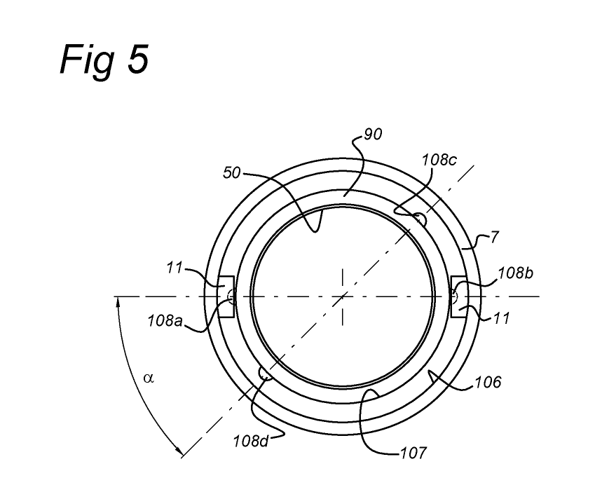

FIG. 5 shows a top view of an embodiment of the female coupling element according to the present invention, wherein four slots are shown. The figures are not necessarily drawn to scale. Identical or similar components in the various figures may have the same reference numerals.

Although the following figures in each case show a female coupling element 3 with a labyrinth-like guide 12 and a male coupling element 2 with a radial projection 6, it will be clear to the skilled person that the female coupling element 3 may also have a radial projection which can form a bayonet fastening together with a labyrinth-like guide of the male coupling element 2. Furthermore, fluid lines 60 are connected to both the male coupling element 2 and to the female coupling element 3 in the figures shown. It will be clear to the skilled person that the following description in each case also applies to the case where a fluid line 60 is connected to one of two coupling elements and the other coupling element is configured as a closure element, for example a cap.

FIG. 1 shows an exploded view of an embodiment of a male coupling element 2 and a female coupling element 3 of a coupling device 1 according to the present invention, wherein both the male and the female coupling element are connected to a fluid line 60, for example a hose.

The male coupling element 2 has a wall 4 having a substantially circular cross section. The wall 4 comprises at least one continuous recess 5 provided along the outer circumference and at least one substantially radially extending projection 6. In the illustrated embodiment, the radially extending projection 6 is provided with a recess 70 in which a connecting element, for example a small chain or cord, can be fitted by means of which the male coupling element 2 and the female coupling element 3 can be coupled to one another. The sole purpose of this connection is to keep the two coupling elements together as a pair.

The female coupling element 3 has a wall 7 having a substantially circular cross section, wherein the wall 7 surrounds a receiving space 8 in which the male coupling element 2 can be accommodated in a fitted manner. In the illustrated embodiment, the female coupling element 3 furthermore has two arms 9. At one end, the arms 9 comprise an operating element 10 and, at the opposite end, a radially extending locking element 11, for example a cam. The arms 9 are rotatably connected to the female coupling element 3 by means of a shaft 21. As is illustrated in FIG. 1, the arms 9 are in a first position in which the cams 11 are substantially outside the receiving space 8 of the female coupling element 3. As a result, the male coupling element 2 can freely be moved in and/or out of the receiving space 8, respectively. By rotation about the shafts 21, the arms 9 can be brought from the first position into the second position. In the second position, the cams 11 will extend through recesses 100 in the wall 7 and engage in the at least one continuous recess 5 provided along the outer circumference in the wall 4 of the male coupling element 2. As a result, a connection is brought about between the female and the male coupling element.

The wall 7 of the female coupling element 3 furthermore comprises a labyrinth-like guide 12 which forms a bayonet fastening in collaboration with the radial projection 6 of the male coupling element 2. The labyrinth-like guide 12 in the wall 7 may be produced, for example, by grinding and/or milling. The labyrinth-like guide 12 has at least one entrance 14 which opens in a free circumferential edge 15 of the wall 7 of the female coupling element 3. The labyrinth-like guide 12 comprises at least one guide part 16 which extends substantially in the axial direction and at least one adjoining guide part 17 which extends substantially in the circumferential direction. The radial projection 6 of the male coupling element 2 can be positioned in the labyrinth-like guide 12 via the entrance 14 by means of displacements in the axial and/or circumferential direction. As a result, the bayonet fastening can be brought about.

In the illustrated embodiment, the guide part 17 extending in the circumferential direction comprises, in a direction facing away from the free circumferential edge 15, a first local widening 20 to form a first stop 80. In a direction facing towards the free circumferential edge 15, the guide part 17 extending in the circumferential direction comprises a second local widening 18 to form a second stop 19.

When the male and the female coupling element are accommodated completely inside one another, the radial projection 6 and the first stop 80 overlap one another. This makes it possible to prevent the radial projection 6 from moving through the labyrinth-like guide 12 when the arms 9 are in the second position, due to a force directed substantially in the circumferential direction.

When the male and female coupling element are not accommodated completely inside one another, the male and the female coupling element are moved in opposite directions and the radial projection 6 and the second stop 19 overlap one another, on account of a force which is substantially directed in the direction of the free circumferential edge 15. Consequently, it is possible to prevent the radial projection 6 from moving through the labyrinth-like guide 12 in the circumferential direction as a result of a force which is directed substantially in the circumferential direction, when the arms 9 are in the first position and the male coupling element 2 can fly out of the female coupling element 3.

In the embodiment shown in FIG. 1, when the male and female coupling elements are accommodated completely inside one another, the arms 9 can be brought in the second position when the radial projection 6 is situated in the local widening 20 of the labyrinth-like guide 12, because the continuous recess 5 provided along the outer circumference of the male coupling element 2 is then situated opposite the cams 11 in such a manner that these can engage with the recess 5. As a result, it is possible to ensure that the connection between the male and the female coupling element is brought about in a correct and safe manner after the bayonet fastening has been brought about correctly.

In the embodiment illustrated in FIG. 1, the labyrinth-like guide 12 is configured as a slot in the wall 7 of the female coupling element 3. In another embodiment, the labyrinth-like guide 12 may be configured as a groove which is provided on the inside of the wall 7.

It is possible to provide the labyrinth-like guide 12 in the wall 7 of the female coupling element 3 during the production thereof. However, it is also possible to grind and/or mill the labyrinth-like guide 12 in a wall of a flange having a substantially circular cross section. In this case, it is important for the diameters of the flange and the female coupling element to correspond to one another so that the male coupling element can still be accommodated inside the female coupling element in a fitted manner. In this way, it is possible to produce a coupling device 1 according to the present invention by means of a simple and/or inexpensive modification of an existing standard cam lock coupling, that is to say without additional bayonet fastening. An advantage thereof is the fact that the male coupling element of the existing cam lock coupling can continue to be used without having to be modified further.

FIG. 1 also shows that the wall 7 of the female coupling element 3 in axial direction comprises a first 101 and a second 102 part that are connected in circumferential direction via a connection element 22. As more clearly shown in FIG. 4, a first end 103 of the first part 101 is connected to a first side 104 of a seat 50 of the female coupling element 3, wherein the first side 104 is facing the receiving space 8. A second end 105 of the first part 101 is connected to a first end 106 of the connection element 22 that is arranged facing the seat 50. The first part 101 of the wall 7 comprises recesses 100 through which the locking elements 11 of the arms 9 extend into the receiving space 8.

In the embodiment of the coupling device 1 according to the present invention shown in FIG. 1, a first side 107 of the first part 101 of the wall 7 that is arranged facing the receiving space 8 comprises a slot 108 that extends in axial direction and is connected to the connection element 22.

FIG. 2 shows the coupling device 1 in its position of use in which the male coupling element 2 is accommodated in the receiving space 8 of the female coupling element 3. The arms 9 have been moved from the first position to the second position by rotating them about the shafts 21. As is illustrated, the cams 11 in the second position extend substantially inside the receiving space 8 and engage with the continuous recess 5 provided along the outer circumference of the male coupling element 2. As a result, a connection is brought about between the female and the male coupling element.

FIG. 2 furthermore shows that a free circumferential edge 51 of the male coupling element 2 is in this case brought into bearing contact with a packing element 90, for example a resilient sealing ring comprising rubber. The sealing ring 90 is positioned between the free circumferential edge 51 and a first side 104 of a seat 50 of the female coupling element 3 in order to prevent or at least reduce leakage between these coupling elements. It can also be seen that sealing ring 90 closes off the slot 108 that extends from the seat 50 in axial direction and is connected to the recess 100. In this way, the coupling device 1 according to the present invention remains leak proof when the arms 9 of the female coupling element are in the second position and a fluid flows through the fluid lines 60 that are coupled by the coupling device 1.

When the arms 9 are in the second position, the radial projection 6, in the illustrated embodiment, is situated in the widening 20 of the guide part 16 which extends substantially in the circumferential direction. In this case, the radial projection 6 is in overlapping contact with the stop 80. Thus, a movement of the radial projection 6 is limited substantially in the circumferential direction. In another embodiment, the radial projection 6 could also be positioned in the widening 18 if the arms 9 are situated in the second position. A movement of the radial projection 6 directed substantially in the circumferential direction will in that case be limited by the overlapping contact between the stop 19 and the radial projection 6.

FIG. 3 shows the coupling device 1 with the arms 9 being in the first position. If in this case a fluid, for example a liquid or a gas, (still) runs through the connected fluid lines, the male coupling element 2 and the female coupling element 3 will be moved in opposite directions as a result of the pressure which the fluid exerts on the coupling elements. Thus, the radial projection 6 of the male coupling element 2 is moved into a widening 18 extending in the direction of the free circumferential edge 15 of the female coupling element 3 and forming part of the guide part 17 of the labyrinth-like guide 12 directed substantially in the circumferential direction. As a result thereof, a movement of the radial projection 6 and thus a movement of the male coupling element 2 is limited substantially in the axial direction. There is a distance (x) between the free circumferential edge 51 of the male coupling element 2 and the sealing ring 90 which rests on the seat 50 of the female coupling element 3. As a result thereof, fluid can leak from the coupling device 1, thus reducing the pressure in the fluid lines. The leaking of fluid is also an indication that the connection between the male and the female coupling elements is no longer completely intact.

If additionally an uncontrolled force directed in the axial and/or circumferential direction unexpectedly acts on the coupling elements of the coupling device 1, for example as a result of torsion in the flexible and/or semi-flexible fluid lines 60 connected to the male coupling element 2 and the female coupling element 3, such as for example hoses, the movement of the radial projection 6 and thus of the male coupling element 2 will be limited substantially in the circumferential direction in such a manner by the overlapping contact between the radial projection 6 and the stop 19 that the radial projection 6 cannot move past the stop 19 and thus cannot get out of the labyrinth-like guide 12. This will make it possible to prevent the male coupling element 2 from flying off the female coupling element 3.

In case the fluid line 60 is to be closed off, the male coupling element 2 or the female coupling element 3 functions as the closure element, for example a cap. In a way analogous to that described above, the coupling device 1 according to the present invention can prevent, for example, vibrations in the closed-off fluid line 60, for example caused by a connected pump, from causing the closure element to fly off the coupling device 1.

Furthermore, FIG. 3 shows a situation in which the sealing ring 90 remains in contact with and parallel to the first side 104 of the seat 50. The slot 108, which is connected to the recess 100, is a breather duct enabling the pressure in the hoses 60 to be efficiently reduced. As a result of this pressure reduction, the forces that are exerted on the male 2 and female 3 coupling elements and because of which these coupling elements are forced in opposite directions with respect to each other can significantly be reduced. In this way the risk of injury to a person and/or damage to the infrastructure that is situated in the vicinity of the coupling device 1 due to the male 2 and female 3 coupling elements flying off each other, can further be reduced.

FIG. 4 shows a combination of a cross-section of a female coupling element 3 and a side view of a male coupling element 2 that is inserted in the receiving space 8 of the female coupling element 3. In this embodiment of the coupling device 1 according to the present invention, the first side 107 of the first part 101 of the wall 7 comprises two slots 108. Both slots 108 extend from the seat 50 in axial direction. The slot 108 shown at the left hand side in FIG. 4, is connected to a recess 100 while the slot 108 shown at the right hand side in FIG. 4 is connected to the connection element 22. In the situation shown in FIG. 4 in which the arm 9 is in the first position, both slots 108 are not blocked by the packing element 90 that remains arranged at and parallel to the first side 104 of the seat 50. Hence, both slots 108 are breather ducts through which fluid from the lines that are connected to the coupling device 1 can escape. This is indicated by the arrows 109. As described above, in this way the forces that are exerted on the male 2 and female 3 coupling elements can significantly be reduced.

FIG. 5 shows a top view of an embodiment of the female coupling element 3 according to the present invention, wherein four slots 108a-108d are shown. Two slots 108a, 108b that extend from the seat 50 in axial direction are connected to the recesses through which the locking elements 11 of the arms 9 protrude into the receiving space 8. The other slots 108c and 108d extend from the seat 50 in axial direction and are connected to first end 106 of the connection element 22. The slots 108c and 108d are arranged along the perimeter of connection element 22 at an angle α with respect to the recesses 100 in the first part 101 of the wall 7 of the female coupling element 3. In the embodiment of the female coupling element 3 as shown in FIG. 5, the angle α is around 45 degrees. However, it will be clear to the skilled person that the angle α can be in the range 0-180 degrees. As described above, the main purpose of having at least two slots 108 is to guarantee the availability of at least one breather duct 108 in a situation in which the packing element 90 is accidentally positioned slanted with respect to the first side 104 of the seat 50 of the female coupling element 3 in a part of the receiving space 8 between the seat 50 and the free circumferential edge 51 of the male coupling element 2. As a result, the reliability of the pressure reduction capability of the coupling device 1 is improved.

The present invention is not limited to the above embodiments which have been described as non-limiting examples. The scope of protection is determined by the meaning of the attached claims which allow for numerous modifications.

1. Coupling device for connecting and/or closing off fluid lines, comprising:
a male coupling element (2) having a substantially circular cross section, at least one continuous recess (5) provided around the outer circumference and at least one projection (6) which extends substantially radially;
a female coupling element (3) which has a wall (7) with a substantially circular cross section which surrounds a receiving space (8) in which the male coupling element (2) can be accommodated in a fitted manner, wherein the female coupling element (3) has at least one arm (9) which, at one end, comprises an operating element (10) and, at an opposite end, at least one radially extending locking element (11), wherein the arm (9) is rotatably connected to the female coupling element (3), wherein the wall (7) has at least one recess (100) through which the locking element (11) can extend into the receiving space (8), wherein the arm (9) can be brought into a first and a second position, wherein, in the first position, the locking element (11) is situated substantially outside the receiving space (8) and the male coupling element (2) can be brought freely into and/or out of the receiving space (8), wherein, in the second position, the locking element (11) extends substantially inside the receiving space (8) and engages with the at least one continuous recess (5) provided around the outer circumference of the male coupling element (2), as a result of which a connection between the coupling elements (2, 3) is established in the position in which the coupling elements (2, 3) are accommodated entirely inside one another, wherein the wall (7) of the female coupling element (3) comprises at least a labyrinth-like guide (12), wherein the labyrinth-like guide (12) comprises at least one entrance (14) which opens in a free peripheral edge (15) of the wall (7), at least one guide part (16) which extends substantially in the axial direction from the entrance (14) and at least one guide part (17) which adjoins the axial guide part (16) and extends substantially in the circumferential direction, wherein the radial projection (6), via the entrance (14) in the axial guide part (16) and the guide part (17) extending in the circumferential direction, can be positioned in the labyrinth-like guide (12) in order to establish the bayonet fastening, wherein the guide part (17) which extends substantially in the circumferential direction is locally widened (18, 20) in the axial direction to form at least one stop (19, 80), wherein the male and female coupling elements accommodated inside one another can be brought into a position in which the radial projection (6) and the at least one stop (19, 80) overlap one another in such a manner that a movement of the male coupling element (2) substantially in the circumferential direction is limited and that it is possible to prevent an uncontrolled force directed in the axial and/or circumferential direction from taking the radial projection (6) past the at least one stop (19), wherein the receiving space (8) further comprises a seat (50) that is arranged in a direction transverse to the wall (7) and opposite the free circumferential edge (15), wherein in axial direction the wall (7) comprises a first (101) and a second (102) part that are connected in circumferential direction via a connection element (22), wherein a first end (103) of the first part (101) is connected to a first side (104) of the seat (50) that is arranged facing towards the receiving space (8) and a second end (105) of the first part (101) is connected to a first end (106) of the connection element (22) that is arranged facing the seat (50), wherein the first part (101) comprises the at least one recess (100), wherein a first side (107) of the first part (101) that is arranged facing the receiving space (8) comprises a slot (108) that extends from the seat (50) substantially in axial direction and is connected to the at least one recess (100) and/or to the connection element (22).

2. Coupling device according to claim 1, wherein in a situation in which the male coupling element (2) and the female coupling element (3) are accommodated entirely inside one another, the slot (108) can be closed off by a packing element (90) that can be arranged between the seat (50) and a free circumferential edge (51) of the male coupling element (2).

3. Coupling device according to claim 1, wherein in a situation in which the at least one arm (9) is in the first position, the slot (108) is a breather duct.

4. Coupling device according to claim 1, wherein the guide part (17) extending in the circumferential direction is widened (20) in a direction facing away from the free circumferential edge (15) to form a first stop (80) in such a manner that, when the male and female coupling elements are accommodated completely inside one another, the radial projection (6) and the first stop (80) overlap one another.

5. Coupling device according to claim 1, wherein the guide part (17) extending in the circumferential direction is widened (18) in a direction facing the free circumferential edge (15) to form a second stop (19) in such a manner that when the male and female coupling elements are not accommodated completely inside one another, the radial projection (6) and the second stop (19) overlap one another.

6. Coupling device according to claim 1, wherein the arm (9) can be brought from the first into the second position when the male and female coupling elements are accommodated completely inside one another, wherein the radially extending locking element (11) of the arm (9) can engage with the at least one continuous recess (5) provided along the outer circumference of the male coupling element (2).

7. Coupling device according to claim 1, wherein the labyrinth-like guide (12) is a slot in the wall (7) of the female coupling element (3).

8. Coupling device according to claim 1, wherein the labyrinth-like guide (12) is an internal groove in the wall (7) of the female coupling element (3).

9. Coupling device according to claim 1, wherein the female and/or the male coupling element comprises a metal and/or a metal alloy.

10. Coupling device according to claim 1, wherein the female and/or the male coupling element comprises a fibre-reinforced plastic.

11. Coupling device according to claim 1, wherein the wall (7) of the female coupling element (3) has a thickness which is in the range from 1-10 mm, and is preferably 5 mm.

12. Line path comprising at least two fluid lines (60) which are connected to one another by means of a coupling device (1) according to claim 1.

13. Line end section comprising at least one fluid line (60) and a closure cap which are connected to one another by a coupling device (1) according to claim 1.

14. Coupling device according to claim 2, wherein in a situation in which the at least one arm (9) is in the first position, the slot (108) is a breather duct.
